(19) United States
(12) Patent Application Publication
(10) Pub. No.: US 2025/0243966 A1
(43) Pub. Date: Jul. 31, 2025

(54) SURFACE-PLATE-EXPANDED ATTRACTION-ATTACHMENT STRUCTURE OF SUPPORT ARM

(71) Applicant: OXTI Pte Ltd, Singapore (SG)

(72) Inventor: Chih-Feng Ho, Singapore (SG)

(21) Appl. No.: 18/423,296

(22) Filed: Jan. 26, 2024

(51) Int. Cl. H01F 7/02; F16M 11/22

(52) U.S. Cl. CPC F16M 11/22

(57) ABSTRACT

A surface-plate-expanded attraction-attachment structure of a support arm is provided, including: a support arm and an attraction-attachment platform arranged at one side of the support arm. The attraction-attachment platform includes an external surface layer and a magnetic body. The external surface layer is attached to the magnetic body. The magnetic body is located between the support arm and the external surface layer. The magnetic body makes the external surface layer attached, through attraction, to the support arm. The support arm is provided with a temporary attraction-attachment platform for temporarily holding a piece of note paper to reminder or instruct other people or to temporarily hold a small part to prevent the small part from falling to the ground and getting lost, or to temporarily hold a specification marking for illustration to other people, or to temporarily hold a tool, such as a spanner, during servicing and repairing.

### BACKGROUND OF THE INVENTION

### (a) Technical Field of the Invention

The present invention relates to a support arm, and more particular to a surface-plate-expanded attraction-attachment structure of a support arm.

### (b) Description of the Prior Art

As shown in FIG. 1, to service and repair an existing screen support arm 100, it is necessary to remove small parts. The small parts are generally small in size. The support arm 110 does not include any function for temporarily attracting and holding the small parts. Consequently, the small parts may easily fall to ground and get lost. Even more, stepping on some of the small parts that have a sharp portion may get hurt.

### SUMMARY OF THE INVENTION

In view of the above, the present invention provides a surface-plate-expanded attraction-attachment structure of a support arm, which comprises: a support arm; and an attraction-attachment platform arranged at one side of the support arm, the attraction-attachment platform comprising an external surface layer and a magnetic body, the external surface layer being arranged on the magnetic body, the magnetic body being located between the support arm and the external surface layer, the magnetic body makes the external surface layer attached, through attraction, to the support arm.

In the above structure, the magnetic body comprises a magnet or a permanent magnet.

In the above structure, the magnetic body is made of a polymer material in which cemented or composite magnetic powder is mixed.

In the above structure, the external surface layer is arranged on the magnetic body by means of adhering, fitting, or welding.

In the above structure, the external surface layer comprises plastics or rubber.

The present invention provides the support arm with a temporary attraction-attachment platform for temporarily holding a piece of note paper to reminder or instruct other people or to temporarily hold a small part to prevent the small part from falling to the ground and getting lost, or to temporarily hold a specification marking for illustration to other people.

### BRIEF DESCRIPTION OF THE DRAWINGS

FIG. 1 is a schematic view showing a known screen support arm.

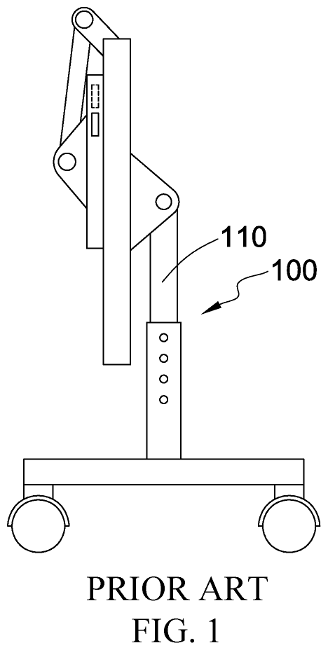

FIG. 2 is a schematic view showing a surface-plate-expanded attraction-attachment structure of a support arm according to the present invention.

FIG. 3 is an exploded view showing the surface-plate-expanded attraction-attachment structure of the support arm according to the present invention.

FIG. 4 is a schematic view showing an attraction-attachment platform according to the present invention.

FIG. 5 is a schematic view showing a way of use of the surface-plate-expanded attraction-attachment structure of the support arm according to the present invention.

### DETAILED DESCRIPTION OF THE PREFERRED EMBODIMENTS

For easy and neat understanding of other features, contents, and advantages of the present invention, and also to more profoundly illustrate efficacy achievable thereby, a detailed description of the present invention will be provided below with reference to the drawings.

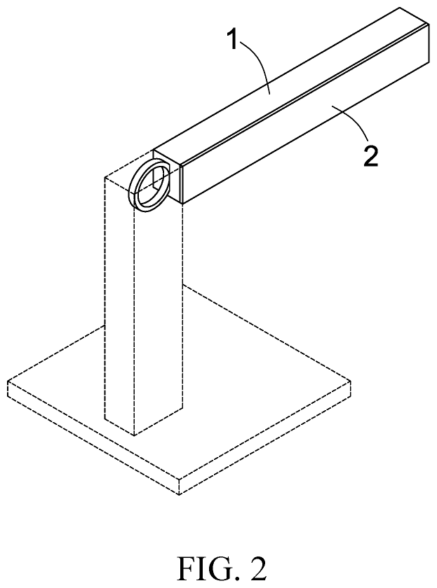

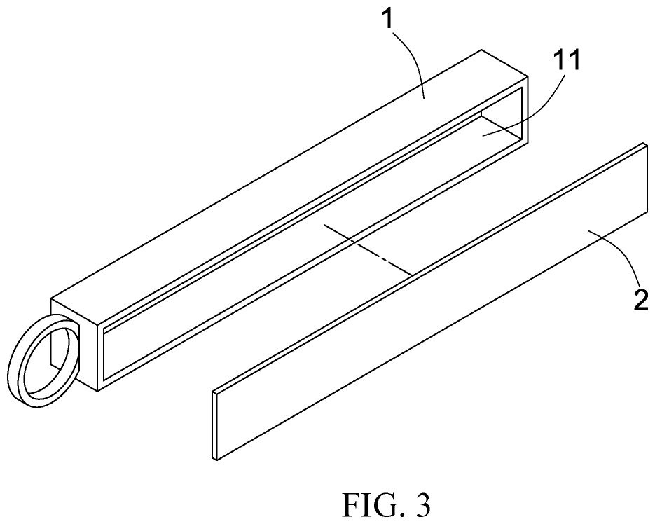

Referring to FIGS. 2 and 3, the present invention provides a surface-plate-expanded attraction-attachment structure of a support arm, which comprises: a support arm 1 and an attraction-attachment platform 2.

The support arm 1 can be a screen support arm, or a support arm for other equipment. The support arm 1 may be provided with a receiving space 11, and the receiving space 11 may receive article to place therein. It is not necessary to include the receiving space 11.

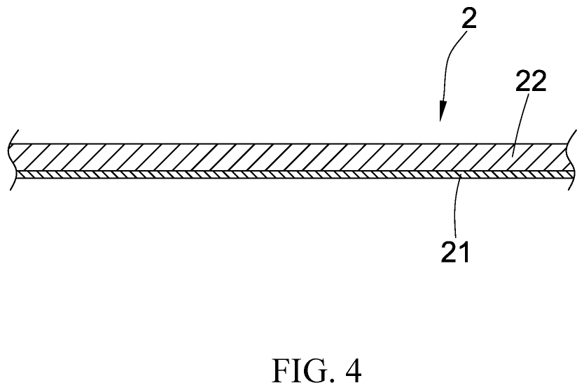

Referring to FIGS. 3 and 4, the attraction-attachment platform 2 is arranged at one side of the support arm 1. The attraction-attachment platform 2 comprises an external surface layer 21 and a magnetic body 22. The external surface layer 21 is attached to the magnetic body 22. The magnetic body 22 is located between the support arm 1 and the external surface layer 21. The magnetic body 22 makes the external surface layer 21 attached to the support arm 1, so that the external surface layer 21 covers and shields the receiving space 11 of the support arm 1. In other words, the attraction-attachment platform 2 is set on and covers the support arm 1.

The external surface layer 21 can be plastics or rubber. The magnetic body 22 can be a magnet or a permanent magnet, or alternatively, the magnetic body 22 is made of a polymer in which cemented or composite magnetic powder is mixed. The external surface layer 21 is attached, through adhering, fitting, or welding, to the magnetic body 22, but not limited thereto.

In the use of the present invention, the attraction-attachment platform 2 is first brought close to the support arm 1 to have the magnetic body 22 facing the receiving space 11 of the support arm 1, such that the magnetic attraction is induced between the magnetic body 22 and the metal-made support arm 1 and the magnetic body 22 thus makes the external surface layer 21 attached, through the attraction, to the support arm 1, and the external surface layer 21 faces outwards. As such, combination between the support arm 1 and the attraction-attachment platform 2 is achieved.

In this way, the attraction-attachment platform 2 can be fast attached, through the magnetic attraction, to the support arm 1, and this provides the attraction-attachment platform 2 with an advantage of easy and fast replacement.

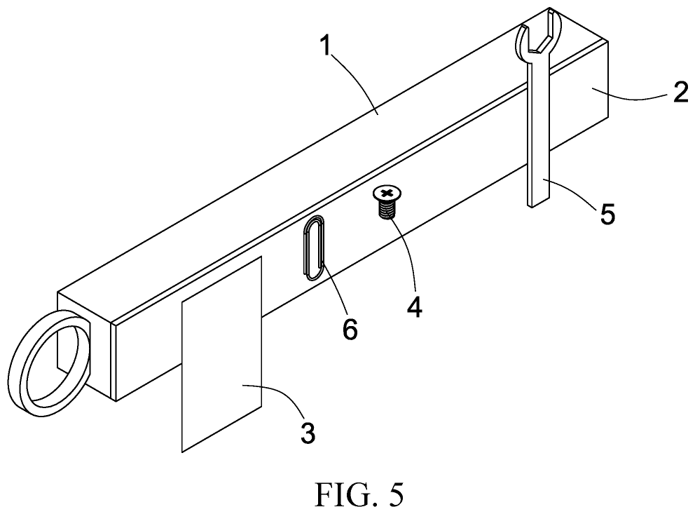

Referring to FIG. 5, the present invention provides the support arm 1 with a temporary attraction-attachment platform 2 for temporarily holding such as a piece of note paper 3 to reminder or instruct other people or to temporarily hold a small part 4 to prevent the small part 4 from falling to the ground and getting lost, or to temporarily hold a specification marking for illustration to other people, or to temporarily hold a tool 5, such as a spanner, during servicing and repairing. The attraction-attachment platform 2 is attached, through magnetic attraction, to the support arm 1, and this provides an advantage that even though the attraction force of the attraction-attachment platform 2 may be limited, small articles, such as note paper 3, small part 4, specification marking, tool 5, and paper clip 6 can be attached, without a pin or a clip, to the support arm 1, ensuring sufficient exquisiteness and non-grotesqueness of the support arm 1 (as there is no additional structure, such as pin and clip, provided on the support arm 1).

1. A support arm surface-plate-expanded attraction-attachment structure, comprising:
a support arm; and
an attraction-attachment platform, which is arranged at one side of the support arm, the attraction-attachment platform comprising an external surface layer and a magnetic body, the external surface layer being arranged on the magnetic body, the magnetic body being located between the support arm and the external surface layer, the magnetic body makes the external surface layer attached, through attraction, to the support arm.

2. The support arm surface-plate-expanded attraction-attachment structure as claimed in claim 1, wherein the magnetic body comprises a magnet or a permanent magnet.

3. The support arm surface-plate-expanded attraction-attachment structure as claimed in claim 1, wherein the magnetic body is made of a polymer material in which cemented or composite magnetic powder is mixed.

4. The support arm surface-plate-expanded attraction-attachment structure as claimed in claim 1, wherein the external surface layer is arranged on the magnetic body by means of adhering, fitting, or welding.

5. The support arm surface-plate-expanded attraction-attachment structure as claimed in claim 1, wherein the external surface layer comprises plastics or rubber.
